(19) United States
(12) Patent Application Publication
(10) Pub. No.: US 2018/0053091 A1
(43) Pub. Date: Feb. 22, 2018

(54) SYSTEM AND METHOD FOR MODEL COMPRESSION OF NEURAL NETWORKS FOR USE IN EMBEDDED PLATFORMS

(71) Applicant: HAWXEYE, INC., Fremont, CA (US)

(72) Inventors: Marios SAVVIDES, Wexford, PA (US); An Pang LIN, Mountain View, CA (US); Shreyas VENUGOPALAN, Pittsburgh, PA (US); Ajmal THANIKKAL, Pittsburgh, PA (US); Karanhaar SINGH, West Windsor, NJ (US); John MATTY, Gibsonia, PA (US); Gavriel ADLER, Brookline, MA (US); Kyle NEBLETT, Seattle, WA (US)

(73) Assignee: HAWXEYE, INC., Fremont, CA (US)

(21) Appl. No.: 15/679,926

(22) Filed: Aug. 17, 2017

Related U.S. Application Data
(60) Provisional application No. 62/376,259, filed on Aug. 17, 2016.

(51) Int. Cl. G06N 3/08; G06N 3/04

(52) U.S. Cl. CPC G06N 3/08; G06N 3/04

(57) ABSTRACT

Embodiments of the present disclosure include a non-transitory computer-readable medium with computer-executable instructions stored thereon executed by one or more processors to perform a method to select and implement a neural network for an embedded system. The method includes selecting a neural network from a library of neural networks based on one or more parameters of the embedded system, the one or more parameters constraining the selection of the neural network. The method also includes training the neural network using a dataset. The method further includes compressing the neural network for implementation on the embedded system, wherein compressing the neural network comprises adjusting at least one float of the neural network.

### CROSS-REFERENCE TO RELATED APPLICATIONS

This application claims benefit of U.S. Provisional Application No. 62/376,259 filed Aug. 17, 2016 entitled “Model Compression of Convolutional and Fully Connected Neural Networks for Use in Embedded Platforms,” which is incorporated by reference in its entirety.

### BACKGROUND

### 1. Field of Invention

This disclosure relates in general to machine learning, and more specifically, to systems and methods of machine learning model compression.

### 2. Description of the Prior Art

Neural networks, such as convolutional neural networks (CNNs) or fully connected networks (FNCs) may be used in machine learning applications for a variety of tasks, including classification and detection. These networks are often large and resource intensive in order to achieve desired results. As a result, the networks are typically limited to machines having the components capable of handling such resource intensive tasks. It is now recognized that smaller, less resource intensive networks are desired.

### SUMMARY

Applicants recognized the problems noted above herein and conceived and developed embodiments of systems and methods, according to the present disclosure, for selecting, training, and compressing machine learning models.

In an embodiment a non-transitory computer-readable medium with computer-executable instructions stored thereon executed by one or more processors to perform a method to select and implement a neural network for an embedded system. The method includes selecting a neural network from a library of neural networks based on one or more parameters of the embedded system, the one or more parameters constraining the selection of the neural network. In certain embodiments, the library may refer to a theoretical set of neural networks, an explicit library with a database, or a combination thereof. The method also includes training the neural network using a dataset. The method further includes compressing the neural network for implementation on the embedded system, wherein compressing the neural network comprises adjusting at least one float of the neural network.

In another embodiment a method for selecting, training, and compressing a neural network includes evaluating a neural network from a library of neural networks, each neural network of the library of neural networks having an accuracy and size component. In certain embodiments, the library may refer to a theoretical set of neural networks, an explicit library with a database, or a combination thereof. The method also includes selecting the neural network from the library of neural networks based on one or more parameters of an embedded system intended to use the neural network, the one or more parameters constraining the selection of the neural network. The method further includes training the selected neural network using a dataset. The method includes compressing the selected neural network for implementation on the embedded system via bit quantization.

In an embodiment a system for selecting, training, and implementing a neural network includes an embedded system having a first memory and a first processor. The system also includes a second processor, a processing speed of the second processor being greater than a processing speed of the first processor. The system further includes a second memory, the storage capacity of the second memory being greater than a storage capacity of the first memory and the second memory including machine-readable instructions that, when executed by the second processor, cause the system to select a neural network from a library of neural networks based on one or more parameters of the embedded system, the one or more parameters constraining the selection of the neural network. In certain embodiments, the library may refer to a theoretical set of neural networks, an explicit library with a database, or a combination thereof. The system also trains the neural network using a dataset. Additionally, the system compresses the neural network for implementation on the embedded system, wherein compressing the neural network comprises adjusting at least one float of the neural network.

### BRIEF DESCRIPTION OF THE DRAWINGS

The present technology will be better understood on reading the following detailed description of non-limiting embodiments thereof, and on examining the accompanying drawings, in which:

FIG. 1 is a schematic diagram of an embodiment of an embedded system, in accordance with an embodiment of the present technology;

FIG. 2 is a schematic diagram of an embodiment of a neural network, in accordance with an embodiment of the present technology;

FIG. 3 is a flow chart of an embodiment of a method for selecting, training, and compressing a network, in accordance with an embodiment of the present technology;

FIG. 4 is a flow chart of an embodiment of a method for selecting a neural network, in accordance with embodiments of the present technology;

FIG. 5 is a graphical representation of an embodiment of a plurality of networks charted against a parameter of an embedded system, in accordance with embodiments of the present technology;

FIG. 6 is a graphical representation of an embodiment of plurality of networks charted against a parameters of an embedded system, in accordance with embodiments of the present technology; and

FIG. 7 is a flow chart of an embodiment of a method for compressing a neural network, in accordance with embodiments of the present technology.

### DETAILED DESCRIPTION OF THE INVENTION

The foregoing aspects, features and advantages of the present technology will be further appreciated when considered with reference to the following description of preferred embodiments and accompanying drawings, wherein like reference numerals represent like elements. In describing the preferred embodiments of the technology illustrated in the appended drawings, specific terminology will be used for the sake of clarity. The present technology, however, is not intended to be limited to the specific terms used, and it is to be understood that each specific term includes equivalents that operate in a similar manner to accomplish a similar purpose.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments,” or “other embodiments” of the present invention are not intended to be interpreted as excluding the existence of additional embodiments that also incorporate the recited features. Furthermore, reference to terms such as “above,” “below,” “upper”, “lower”, “side”, “front,” “back,” or other terms regarding orientation are made with reference to the illustrated embodiments and are not intended to be limiting or exclude other orientations.

Embodiments of the present disclosure include systems and methods for selecting, training, and compressing neural networks to be operable on embedded systems, such as cameras. In certain embodiments, neural networks may be too large and too resource demanding to be utilized on systems with low power consumption, low processing power, and low memory capacity. By selecting networks based on system conditions and subsequently compressing the networks after training, the networks may be sufficiently compressed to enable operation in real or near real time on embedded systems. Moreover, in embodiments, the networks may be operated slower than real time, but still faster than an uncompressed neural network. In embodiments, the neural network is selected from a library of networks, for example, a library of networks that has proven effective or otherwise useful for a given application. The selection is based on one or more parameters of the embedded system, such as processing speed, memory capacity, power consumption, intended application, or the like. Initial selection may return one or more networks that satisfy the one or more parameters. Thereafter, features of the network such as speed and accuracy may be further evaluated based on the one or more parameters. In this manner, the fast, most accurate network for a set of parameters of the embedded system may be selected. Thereafter, the network may be trained. Subsequently, the network is compressed to enable storage on the embedded system while still enabling other embedded controls, such as embedded software, to run efficiently. Compression may include bit quantization to reduce the number of bits of the trained network. Furthermore, in certain embodiments, extraneous or redundant information in the data files storing the network may be removed, thereby enabling installation and processing on embedded systems with reduced power and memory capabilities.

Traditional convolutional neural networks (CNNs) and fully connected networks may be large and resource intensive. In certain embodiments, the CNNs and fully connected networks may be integrated into an executable computer software program. For example, the files that store the models are often very large, too large to be utilized with embedded systems having limited memory capacity. Additionally, the networks may be large and complex, consuming resources in a manner that makes running the networks in real time or near-real time unreasonable for smaller, less powerful systems. As such, compression of these networks or otherwise reducing the size of these networks may be desirable. In certain embodiments, removing layers or kernels or reducing their size may enable the networks to be utilized with embedded systems while still maintaining sufficient accuracy. Additionally, compression may be performed using bit quantization.

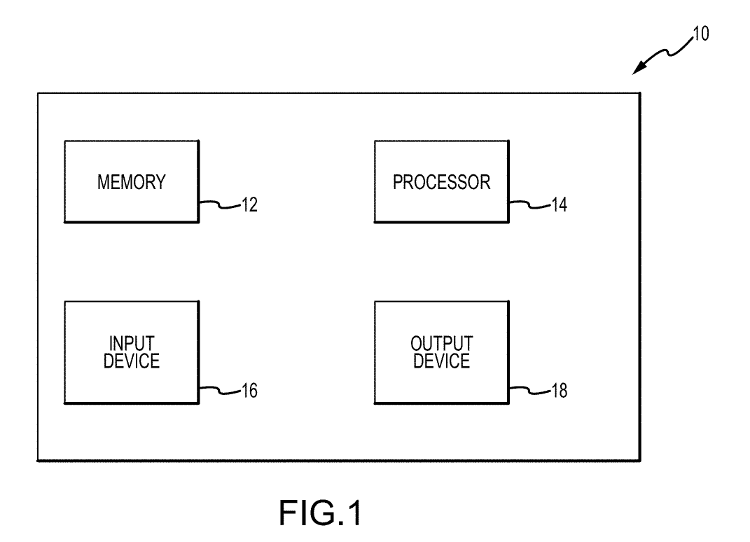

FIG. 1 is a schematic diagram of an embedded system 10 that may be utilized to perform one or more digital operations. In certain embodiments, the embedded system 10 is a camera, such as a video camera, still camera, or a combination thereof. As such, the embedded system 10 may include a variety of features to enable image capture and processing, such as a lens, image sensor, or the like. Additionally, it should be understood that the embedded system 10 may not be a camera. For example, the embedded system 10 may include any low-power or reduced processing computer system with embedded memory and/or software such as smart phones, tablets, wearable devices, or the like. In the illustrated embodiment, the embedded system 10 includes a memory 12, a processor 14, an input device 16, and an output device 18. For example, in certain embodiments, the memory 12 may be a non-transitory (not merely a signal), tangible, computer-readable media, such as an optical disc, solid-state flash memory, or the like, which may include executable instructions that may be executed by the processor 14. The processor 14 may be one or more microprocessors. The input device 16 may be a lens or image processor, in embodiments where the embedded system 10 is a camera. Moreover, the input device 16 may include a BLUETOOTH transceiver, wireless internet transceiver, Ethernet port, universal serial bus port, or the like. Furthermore, the output device 18 may be a display (e.g., LED screen, LCD screen, etc.) or a wired or wireless connection to a computer system. It should be understood that the embedded system 10 may include multiple input and output devices 16, 18 to facilitate operation. As will be described in detail below, the memory 12 may receive one or more instructions from a user to access and execute instructions stored therein.

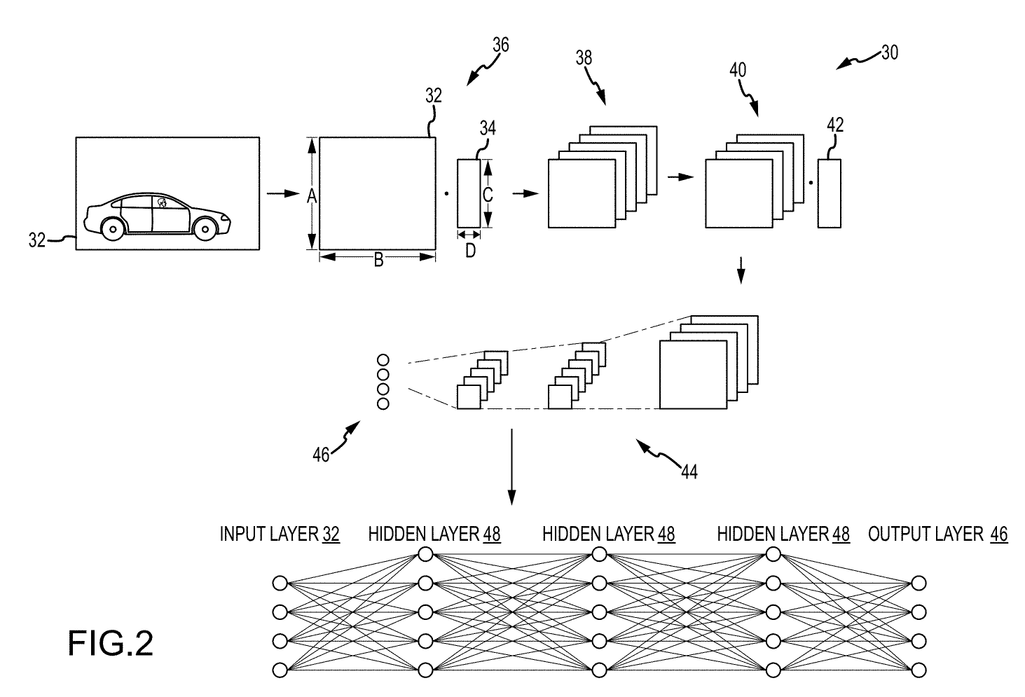

As described above, neural networks may be used for image classification and detection. Moreover, neural networks have a host of other applications, such as but not limited to, character recognition, image compression, prediction, and the like. FIG. 2 is a schematic diagram of a CNN 30. In the illustrated embodiment, an input 32 to presented to the network in the form of a photograph. It should be understood that while the illustrated embodiment includes the photograph, in other embodiments the input 32 may be a video, document, or the like. The input 32 is segmented, for example, into a grid, and a filter or kernel of fixed size is scanned across the input 32 to extract features from it. The input 32 is processed as a matrix of pixel values. As the kernel moves across the matrix of pixels, which is referred to as the stride of the kernel, the value of each kernel is output to a convolved feature or feature map. In the illustrated embodiment, the input 32 is an image having a resolution of A×B and a kernel 34 having a size of C×D is utilized to process the input 32 in a convolution step 36. In an embodiment where the input 32 has a size of 5×5 and the kernel 34 has a size of 3×3 with a stride of 1, the convolved feature will be 3×3. That is, the 3×3 kernel 34 with a stride of one will be able to move across the 5×5 input 32 nine times. It should be appreciated that different kernels 34 may be utilized to perform different functions. For example, kernels 34 may be designed to perform edge detection, sharpening, and the like. The number of kernels 34 used is referred to as the depth. Each kernel 34 will produce a distinct feature map, and as a result, more kernels 34 lead to a greater depth. This may be referred to as stacking.

Next, a nonlinearity operation 38, such as a Rectified Linear Unit (e.g., ReLU) is applied per pixel and replaces negative pixel values in the feature map with zero. The ReLU introduces non-linearity to the network. It should be appreciated that other non-linear functions, such as tanh or sigmoid may be utilized in place of ReLU.

In the illustrated embodiment, a pooling operation 40 is performed after the nonlinearity operation 38. In pooling, the dimensions of the feature maps are decreased without eliminating important features or information about the input 32. For example, a filter 42 may be applied to the image and values from the feature map may be extracted based on the filter 42. In certain embodiments, the filter 42 may extract the largest element within the filter 42, an average value within the filter 42, or the like. It should be appreciated that each feature map has the pooling operation 40 performed. Therefore, for deeper networks additional processing is utilized by pooling multiple feature maps, even though pooling is intended to make inputs 32 smaller and more manageable. As will be described below, this additional processing may slow down the final product and be resource intensive, thereby limiting applications. Multiple convolution steps 36 may be applied to the input 32 using different sized filters 34. Moreover, in the illustrated embodiment, multiple non-linearity and pooling operations 38, 40 may also be applied. The number of steps, such as convolution steps 36, pooling operations 40, etc. may be referred to as layers in the network. As will be described below, in certain embodiments, these layers may be removed from certain networks.

In certain embodiments, the CNN 30 may include fully connected components, meaning that each neuron in a layer is connected to every neuron in the next layer. The fully connected layer 44 does not show each connection between the neurons for clarity. The connections enable improved learning of non-linear combinations of the features extracted by the convolution and pooling operations. In certain embodiments, the fully connected layer 44 may be used to classify the input based on training datasets as an output 46. In other words, the fully connected layer 44 enables a combination of the features from the previous convolution steps 36 and pooling steps 40. In the embodiment illustrated in FIG. 2, the fully connected layer 44 is last to connect to the output layer 46 and construct the desired number of outputs. It should be appreciated that, training may be performed by a variety of methods, such as backpropagation.

FIG. 2 also includes an expanded view of the fully connected layer 44 to illustrate the connections between the neurons. It should be appreciated that this expanded view does not necessarily include each neuron. By way of example only, the input layer 32 (which may be the transformed input after the convolutional step 36, nonlinearity operation 38, and pooling operation 40), includes four neurons. Thereafter, three hidden layers 48 include five neurons. Each of the four neurons from the input layer 32 is utilized as an input to each of the five neurons of the first hidden layer 48. In other words, the fully connected layer 44 connects every neuron in the network to every neuron in adjacent layers. Thereafter, the neurons from the first hidden layer 48 are each used as inputs to the neurons of the second hidden layer 48 and so on with the third hidden layer 48. It should be appreciated that any suitable number of hidden layers 48 may be used. The results from the hidden layers 48 are then each used as inputs to generate an output 46.

Multiple layers, kernels, and steps may increase the size and completely of the networks, thereby creating problems when attempting to run the networks on low power, low processing systems. Yet, these systems may often benefit from using networks to enable quick, real time or near-real time classification of objects. For example, in embodiments where the embedded system 10 is a camera, fully connected networks and/or CNNs may be utilized to identify features that are humans, vehicles, or the like. As such, different security protocols may be initiated based on the classifications of the inputs 32.

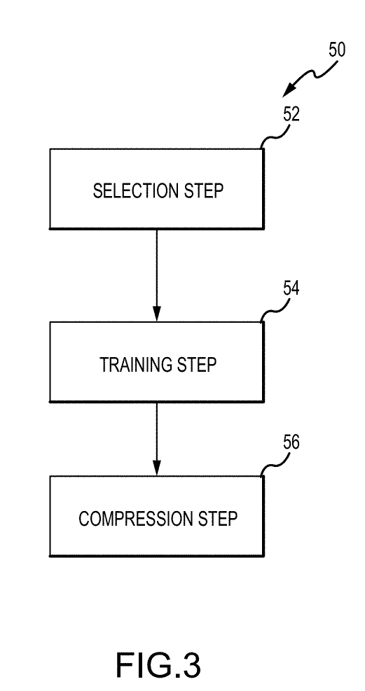

FIG. 3 is a method 50 for data and model compression. The method 50 enables the network (e.g., CNN, fully connected network, neural network, etc.) to be selected, trained, and compressed to enable operation on the embedded system 10. For example, a selection step enables selection of a reduced size network (block 52). As will be described below, the selection step reduces the size of the network by removing layers, removing kernels, or both. That is, the selection step may review parameters of the embedded system 10, such as processor speed, available memory, etc. and determine one or more networks which may operate within the constraints of the embedded system 10. That is, the parameters of the embedded system 10 (e.g., speed, accuracy, size, etc.) may be utilized to develop one or more thresholds to constrain selection of the network. Next, a training step is utilized to teach the network (block 54). For example, back propagation algorithms may train the networks. Then, a compression step reduces the size of the network (block 56). As will be described below, the compression step may utilize bit quantization, resolution reduction, or the like to reduce the size of the network to enable the embedded system 10 to run the network in real or near-real time. In this manner, the network may be prepared, trained, and compressed for use on the embedded system 10. One or more steps of the method 50 may be performed on a computer system, for example, a computer system including one or more memories and processors as described above.

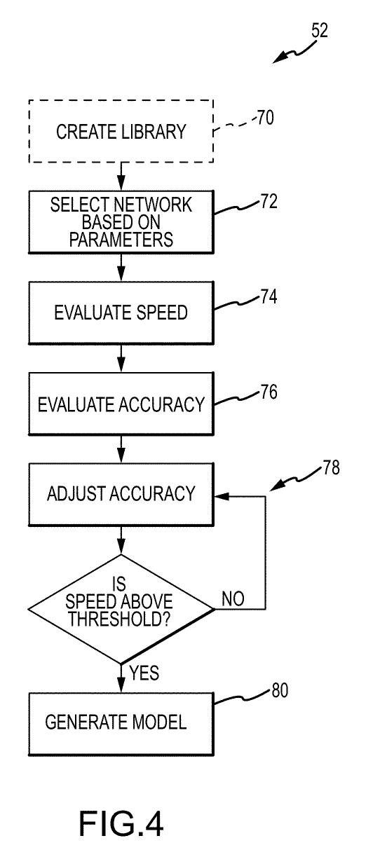

FIG. 4 is a flow chart of an embodiment of the selecting step 52. As described above, in certain embodiments, the selecting step 52 is used to determine which neural network model structure should be used, for example, based on parameters of the embedded system 10. That is, for the embodiment of the embedded system 10 illustrated in FIG. 1, the processor 14 may have a certain operational capacity and the memory 12 may have a certain storage capacity. These factors may be used as limits to determine the network structure. For example, the network (or the program that integrates the network) may be limited to a certain percentage of the memory 12 to account for other onboard programs used for operation of the embedded system 10. Similarly, the load drawn from the processor 14 may also be limited to a certain percentage to account for the onboard programs. In this manner, selection of the neural network is first constrained by the system running it, thereby reducing the likelihood that the network will be incompatible with the embedded system 10.

In certain embodiments, one or more libraries of neural networks may be preloaded, for example, on a computer system, such as a cloud-based or networked data system (block 70). These one or more libraries may be populated by neural networks from literature or past experimentation that have illustrated sufficient characteristics regarding accuracy, speed, memory consumption, and the like. In certain embodiments, the libraries may refer to a theoretical set of neural networks, an explicit library with a database, or a combination thereof. Moreover, different networks may be generated and developed over time as one or more networks is found to be more capable and/or adept at identifying certain features. Once the library is populated, a network is selected from the library that satisfies the parameters of the embedded system 10 (block 72). The parameters may include memory, processor speed, power consumption, or the like. In certain embodiments, an algorithm may be utilized to evaluate each network in the library and determine whether the network is suitable for the given application. For example, the algorithm may be in the form of a loop that individually evaluates the networks for a first property. If that first property is satisfactory, then the loop may evaluate the networks for a second property, a third property, and so forth. In this manner, potential networks may be quickly identified based on system parameters.

In the illustrated embodiment, the speed of the network is also evaluated (block 74). For example, there may be a threshold speed that the algorithm compares to the networks in the library of networks. In certain embodiments, the threshold speed is no more than a threshold number of frames per second, such as 5-15 frames per second. In certain embodiments, characteristics of the network may be plotted against the speed. Thereafter, the accuracy of the network is evaluated (block 76). For example, in certain embodiments, reducing the size and processing consumption of a network may decrease the accuracy of the network. However, a decrease in accuracy may be acceptable in embodiments where the characterizations made by the networks are significantly different. For example, when distinguishing between a pedestrian and a vehicle, a lower accuracy may be acceptable because the difference between the objects and may be more readily apparent. However, when distinguishing between a passenger car and a truck, the higher accuracy may be desired because there are fewer distinguishing characteristics between the two. Moreover, accuracy may be sacrificed to enable the installation of the network on the embedded system 10 in the first place. In other words, it is more advantageous to include a lower accuracy network than not include one at all.

As described in detail above, the selection step 52 involves identifying networks based on a series of parameters defining at least a portion of the embedded system 10. For example, the size of the memory 12, the processor 14 speed, the power consumption, and the like may be utilized to define parameters of the embedded system 10. After the network is selected based on at least one parameter and accuracy, the network may be further analyzed by comparing speed and accuracy (block 78). That is, the speed may be sacrificed, in certain embodiments, to achieve improved accuracy. However, sacrifices to speed may still be maintained above the threshold described above. In other words, speed is not sacrificed for accuracy to the extent that the network becomes too slow to run in real or near-real time. Thereafter, the final network model is generated (block 80). For example, the final network model may include the number of layers in the network, the size of the kernels, and number of kernels, and the like. In this manner, the selection step 52 may be utilized to evaluate a plurality of neural networks from a library to determine which network is suited for the parameters of the embedded system 10.

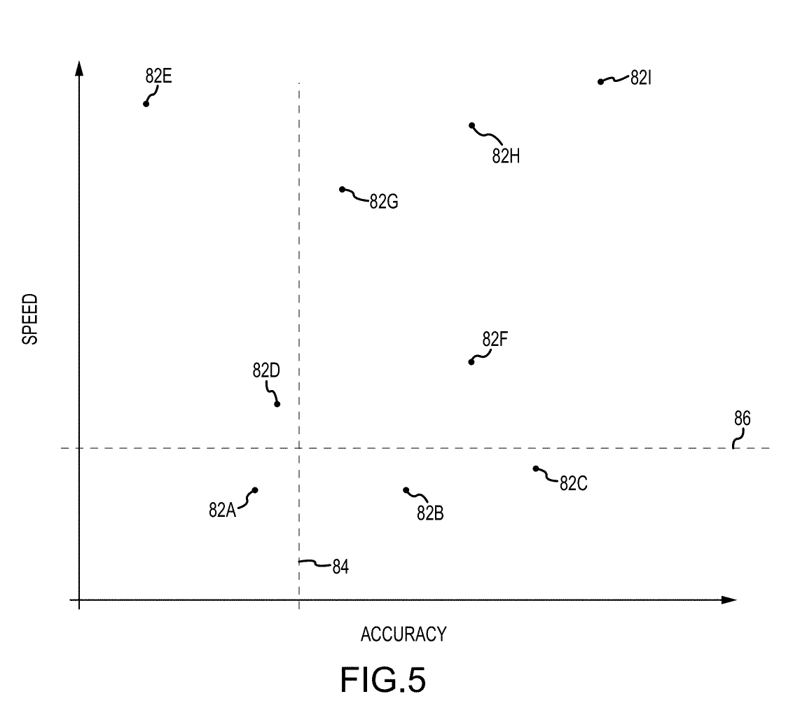

FIG. 5 is a graphical representation of an embodiment of a plurality of networks 82 plotted against parameters of the embedded system 10. In the embodiment illustrated in FIG. 5, the horizontal axis corresponds the accuracy of the networks 82 and the vertical axis corresponds to the speed. Thresholds 84, 86 are positioned on the graphical representation for clarity to illustrate restraints put on the selection based on the system parameters. For example, in the illustrated embodiment, the threshold 84 corresponds to a minimum accuracy. The threshold 86 corresponds to a minimum speed. As such, networks 82 that fall below either threshold 84, 86 are deemed unsuitable and are not selected for use with the embedded system. In the illustrated embodiment, networks 82A, 82B, and 82C fall below the speed threshold 86 and the networks 82A, 82D, and 82E fall below the accuracy threshold 84. Accordingly, the large library of networks 82 that may be stored can be quickly and efficiently culled and analyzed for networks 82 that satisfy parameters of the embedded system 10.

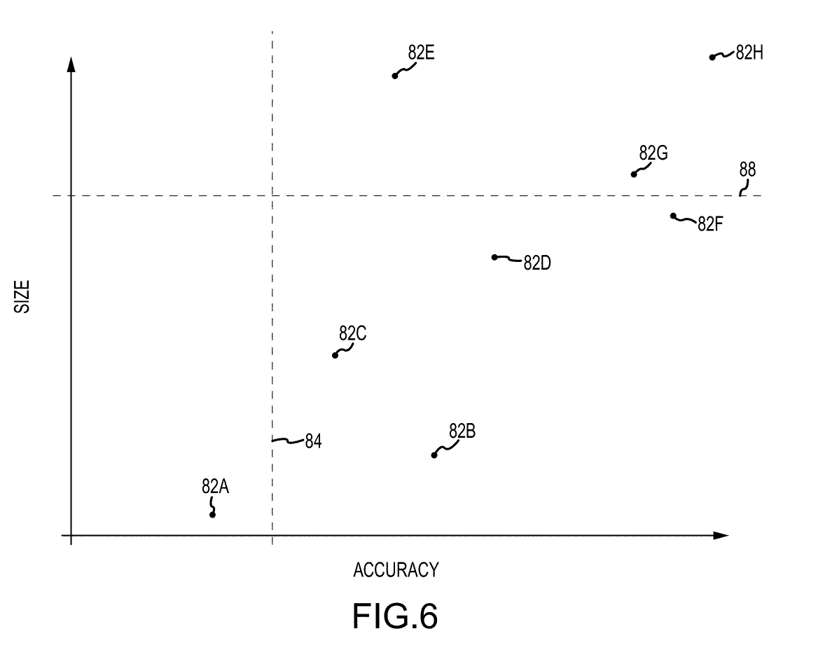

FIG. 6 is a graphical representation of an embodiment of the plurality of networks 82 plotted against parameters of the embedded system 10. In the embodiment illustrated in FIG. 6, the horizontal axis corresponds to accuracy and the vertical axis corresponds to size. The accuracy threshold 84 and a size threshold 88 are positioned on the graphical representation for clarity to illustrate restraints put on the selection based on the system parameters. For example, in the illustrated embodiment, the threshold 84 corresponds to a minimum accuracy. The threshold 86 correspond to a maximum size. As such, networks 82 that fall below the accuracy threshold 84 and/or above the size threshold 88 are deemed unsuitable and are not selected for use with the embedded system. In the illustrated embodiment, network 82A falls below the accuracy threshold 84 and networks 82E, 82G, 82H fall above the size threshold. In certain embodiments, multiple parameters may be compared across different networks 82 to identify one or more networks 82 that may be suitable for use with the one or more parameters of the embedded system 10.

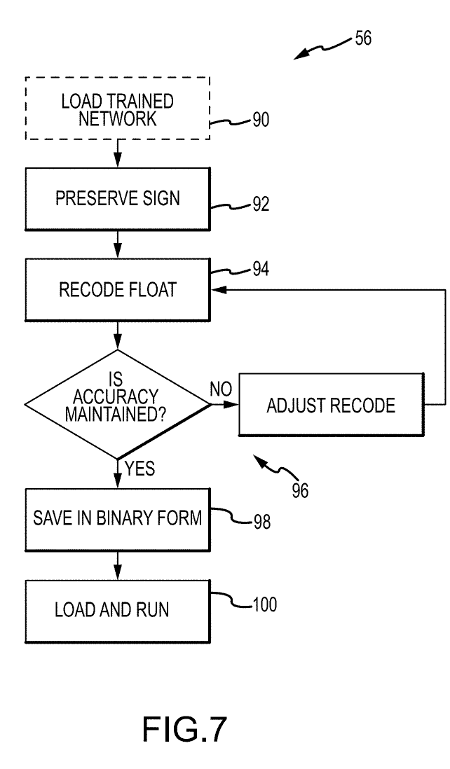

FIG. 7 is a flow chart of an embodiment of the compression step 56. As described above, the compression step 56 reduces the size of the network, thereby enabling the network to be stored and run on the embedded system 10 with reduced memory capacities. Moreover, running the smaller network also takes less resource draw from the processor 14. In certain embodiments, the compression step 56 uses bit quantization. When storing data, numbers may often be stored as floats, which typically include 32 bits. However, 32 bits is used as an example and in certain embodiments any reasonable number of bits may be used. In embodiments with 32 bits, one bit is the sign (e.g., positive, negative), eight bits are exponent bits, and 23 are fraction bits. Together, these 32 bits form the final float. Adding or removing bits from the float changes the precision, or in other words, the number of decimal points to which the number is accurate. As such, more bits means the float can be accurate to more decimal places and fewer bits means the float is accurate to fewer decimal places. Yet, using the method of the disclosed embodiments, bits may be removed to reduce the size of the network while simultaneously maintaining sufficient accuracy to run the network. As will be described below, in certain embodiments, kernels 34 that were trained by the model are truncated to fewer bits by re-encoding the float closely to another float with fewer exponent and fraction fits. This process reduces precision, but relevant data can still be encoded with fewer bits without sacrificing significant accuracy.

During the compression step 56, the natural 32 bit form of the trained network is loaded (block 90). In other words, after the training step 54 the trained network is unmodified before proceeding to the compression step 56. Next, the sign bit is preserved (block 92). Thereafter, the float is recoded (block 94). Eight of the remaining 31 bits belong to the exponent bit while 23 of the remaining 31 bits belong to the fractional bit. In recoding, the total remaining bits are reduced to approximately eight or nine bits. That is, the value of the float at 31 bits is adjusted and modified such that 8 or 9 bits represents a substantially equal value. That is, the value of the float at 31 bits is compared to the value of a float having only 8 or 9 bits. If the value is within a threshold, then the float with the reduced number of bits may be substituted for the larger float. As such, the size is reduced by approximately 25 percent. The sign preservation (block 92) and recoding (block 94) steps are repeated for each value in the matrix produced via the training step 54. Next, a recoding limit is adjusted (block 96). As described above, recoding may adjust the number of bits to approximately eight or nine. At block 96, this recoding is evaluated to determine whether accuracy is significantly decreased. If so, the recoding is adjusted to include more bits. If not, the compression step 56 proceeds. This modified matrix is then saved in a binary form (block 98). As used herein, binary form refers to any file that is stored and is not limited to non-human readable formats. Subsequently, the model can be loaded from the binary form and run to generate results (block 100). As a result, the trained neural network is modified such that minimal information is utilized to maintain the accuracy, thereby enabling smaller, less powerful embedded systems 10 to run the networks.

Embodiments of the present disclosure describe systems and methods for selecting, training, and compressing networks for use with the embedded system 10. In embodiments, the embedded systems 10 include structures having the memory 12 and processor 14. These structures often have reduced capacities compared to larger systems, and as a result, networks may be run efficiently, or at all, on the systems. The method 50 includes a selection step 52 where a network is selected based on one or more parameters of the embedded system 10. For example, the embedded system 10 may have a reduced memory 12 capacity or slower processor 14 speed. Those constraints may be utilized to select a network that fits within the parameters, such as a network with one or more kernels or layers removed to reduce the size or improve the speed of the network. Additionally, the method 50 includes the training step 54 where the selected network is trained. Moreover, the method includes the compression step 56. In certain embodiments, the compression step 56 uses bit quantization to reduce large bit floats into smaller bit floats to enable compression of the data stored in the trained networks, thereby enabling operation on the embedded system 10. In this manner, networks may be used in real or near-real time on embedded systems 10 having reduced operating parameters.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A non-transitory computer-readable medium with computer-executable instructions stored thereon executed by one or more processors to perform a method to select and implement a neural network for an embedded system, the method comprising:
selecting a neural network from a library of neural networks based on one or more parameters of the embedded system, the one or more parameters constraining the selection of the neural network;
training the neural network using a dataset; and
compressing the neural network for implementation on the embedded system, wherein compressing the neural network comprises adjusting at least one float of the neural network.

2. The non-transitory computer-readable medium of claim 1, further comprising loading the compressed neural network on to the embedded system.

3. The non-transitory computer-readable medium of claim 1, wherein selecting the neural network comprises:
comparing a feature of the neural network against the one or more parameters of the embedded system;
disregarding the neural network if the feature is outside of a threshold range of the one or more parameters;
selecting the neural network if the feature is within the threshold range of the one or more parameters;
comparing an accuracy of the neural network to a second neural network from the library of neural networks, the second neural network having the feature within the threshold range of the one or more parameters; and
selecting the neural network with the higher accuracy.

4. The non-transitory computer-readable medium of claim 3, wherein the feature comprises speed, accuracy, size, or a combination thereof.

5. The non-transitory computer-readable medium of claim 1, wherein compressing the neural network comprises:
preserving a sign bit of a float indicative of a value in a trained neural network;
reducing a number of bits of the float; and
saving the compressed neural network in a binary form.

6. The non-transitory computer-readable medium of claim 5, wherein the number of bits of the float is reduced by at least 10 percent.

7. A method for selecting, training, and compressing a neural network, the method comprising:
evaluating a neural network from a library of neural networks, each neural network of the library of neural networks having an accuracy, a speed, and a size component;
selecting the neural network from the library of neural networks based on one or more parameters of an embedded system intended to use the neural network, the one or more parameters constraining the selection of the neural network;
training the selected neural network using a dataset; and
compressing the selected neural network for implementation on the embedded system via bit quantization.

8. The method of claim 7, further comprising saving the compressed neural network in binary form.

9. The method of claim 7, further comprising comparing an accuracy of the selected neural network with an accuracy of a second network and selecting the second network in favor of the selected network when the accuracy of the second network is greater than or equal to the accuracy of the first network.

10. The method of claim 9, comprising comparing a speed of the selected network with a speed of the second network and selecting the selected network if the speed of the second network is outside of a threshold range.

11. The method of claim 7, where the one or more parameters comprise a memory capacity, a processor speed, or a combination thereof.

12. The method of claim 7, wherein bit quantization comprises reducing a number of bits representing a float indicative of a value in a matrix by at least 10 percent.

13. The method of claim 7, wherein the neural network comprises a convolutional neural network or a fully connected network.

14. The method of claim 7, wherein compressing the neural network comprises:
preserving a sign bit of a float indicative of a value in a trained neural network;
reducing a number of bits of the float; and
saving the compressed neural network in a binary form

15. A system for selecting, training, and implementing a neural network, the system comprising:
an embedded system having a first memory and a first processor,
a second processor, a processing speed of the second processor being greater than a processing speed of the first processor; and
a second memory, the storage capacity of the second memory being greater than a storage capacity of the first memory and the second memory including machine-readable instructions that, when executed by the second processor, cause the system to:
select a neural network from a library of neural networks based on one or more parameters of the embedded system, the one or more parameters constraining the selection of the neural network;
train the neural network using a dataset; and
compress the neural network for implementation on the embedded system,
wherein compressing the neural network comprises adjusting at least one float of the neural network.

16. The system of claim 15, further comprising loading the compressed neural network on to the embedded system.

17. The system of claim 15, wherein selecting the neural network comprises:
comparing a feature of the neural network against the one or more parameters of the embedded system;
disregarding the neural network if the feature is outside of a threshold range of the one or more parameters;
selecting the neural network if the feature is within the threshold range of the one or more parameters;
comparing an accuracy of the neural network to another second neural network from the library of neural networks, the second neural network having the feature within the threshold range of the one or more parameters; and
selecting the neural network with the higher accuracy.

18. The system of claim 17, wherein the one or more features comprises speed, accuracy, size, or a combination thereof.

19. The system of claim 15, wherein compressing the neural network comprises:
preserving a sign bit of a float indicative of a value in a trained neural network;
reducing a number of bits of the float; and
saving the compressed neural network in a binary form.

20. The system of claim 15, wherein the number of bits of the float is reduced by at least 10 percent.
